(19) United States
(12) Patent Application Publication
(10) Pub. No.: US 2026/0141870 A1
(43) Pub. Date: May 21, 2026

(54) ELECTRONIC APPARATUS AND CONTROL METHOD THEREOF

(71) Applicant: Samsung Electronics Co., Ltd., Suwon-si (KR)

(72) Inventor: Minhoon LEE, Suwon-si (KR)

(21) Appl. No.: 19/367,222

(22) Filed: Oct. 23, 2025

Related U.S. Application Data
(63) Continuation of application No. PCT/KR2025/013487, filed on Sep. 2, 2025.

(30) Foreign Application Priority Data
Nov. 21, 2024 (KR) 10-2024-0167046

(51) Int. Cl. G09G 3/34

(52) U.S. Cl. CPC G09G 3/3426; G09G 2310/08

(57) ABSTRACT

An electronic apparatus includes: a display panel; a backlight unit including a plurality of light-emitting elements; and at least one processor, comprising processing circuitry, individually and/or collectively, configured to control the display panel to: display a screen corresponding to an image based on the image being input, and generate control information for controlling each of the plurality of light-emitting elements based on the image, and provide the generated control information to the backlight unit, wherein the backlight unit includes: a plurality of pixel integrated circuits (ICs) arranged in a plurality of columns and a plurality of rows, each configured to provide a driving current to each of the plurality of light-emitting elements, and a driver IC configured to sequentially output the driving current to a plurality of first pixel ICs arranged in a first column and a plurality of second pixel ICs arranged in a second column using one source signal within a specified time period based on the control information.

### CROSS-REFERENCE TO RELATED APPLICATIONS

This application is a continuation of International Application No. PCT/KR2025/013487 designating the United States, filed on Sep. 2, 2025, in the Korean Intellectual Property Receiving Office and claiming priority to Korean Patent Application No. 10-2024-0167046, filed on Nov. 21, 2024, in the Korean Intellectual Property Office, the disclosures of each of which are incorporated by reference herein in their entireties.

### BACKGROUND

### Field

The disclosure relates to an electronic apparatus that may simplify a configuration of a backlight unit and a control method thereof.

### Description of Related Art

As electronic technology advances, various types of electronic devices have been developed and distributed. In particular, display devices used in various places such as homes, offices, and public places have been continuously developing in recent years.

Recently, the display device uses a backlight unit and uses many light-emitting elements to improve image quality. Therefore, a lot of wiring is required to control many light-emitting elements.

### SUMMARY

Embodiments of the disclosure provide an electronic apparatus that may simplify a configuration of a backlight unit and a control method thereof.

According to an example embodiment of the present disclosure, provided is an electronic apparatus including: a display panel; a backlight unit comprising circuitry including a plurality of light-emitting elements; and at least one processor, comprising processing circuitry, individually and/or collectively, configured to control the display panel to: display a screen corresponding to an image based the image being input, and generate control information configured to control each of the plurality of light-emitting elements based on the image, and provide the generated control information to the backlight unit, wherein the backlight unit includes: a plurality of pixel integrated circuits (ICs) arranged in a plurality of columns and a plurality of rows, each configured to provide a driving current to each of the plurality of light-emitting elements, and a driver IC configured to sequentially output the driving current to a plurality of first pixel ICs arranged in a first column and a plurality of second pixel ICs arranged in a second column using one source signal within a specified time period based on the control information.

The driver IC may be configured to provide a first start signal to the first pixel IC in the first column and a second start signal to the first pixel IC in the second column.

The driver IC may be configured to generate the first start signal, which is turned on during one clock signal period within the specified time period, and generate the second start signal, which is turned on during one clock signal period within the specified time period, the second start signal being turned on during the one clock signal period after a time acquired by multiplying the clock signal period by the number of pixel ICs in one column from a turn-on time point of the first start signal.

The driver IC may output the first start signal, which is turned on during one clock signal period, and output the second start signal based on the first start signal being output, the second start signal being turned on after the time acquired by multiplying the clock signal period by the number of pixel ICs in one column.

The driver IC may be configured to provide a clock signal operated at a specified period to the plurality of pixel ICs.

The driver IC may be configured to output the driving current using the source signal, the driving current having a current magnitude corresponding to brightness information of the pixel IC selected by the clock signal and the start signal.

The driver IC may be configured to provide the driving current to each of the plurality of ICs by a number greater than or equal to a specified number of times for each of a plurality of frames included in the image.

Each of the plurality of pixel ICs may be configured to output the driving current from the source signal in a hold state based on a received start signal transitioning and a received clock signal transitioning.

Each of the plurality of pixel ICs may be configured to provide the received clock signal to a pixel IC disposed in a next column, and provide a transitioned start signal to a next pixel IC in the same column after a specified time based on the received start signal transitioning.

The driver IC may be configured to provide a third start signal to the first pixel IC in the first column, and a last pixel IC in the first column may be configured to output the driving current to the light-emitting element in a hold state based on the received start signal transitioning, and provide the start signal to the first pixel IC in the second column after a specified time.

The driver IC may be configured to output the third start signal to the first pixel IC in the first column, the third start signal configured to turn on in a period unit in which the clock signal period is multiplied by the number of the plurality of first pixel ICs and the plurality of second pixel ICs.

The electronic apparatus may further include a circuit board on which the driver IC and the plurality of pixel ICs are arranged, wherein a first wiring region and a second wiring region are disposed on one surface of the circuit board, the first wiring region being commonly connected to a first output port configured to output the source signal from the driver IC and to a first input port of the first pixel IC and the second pixel IC, and the second wiring region connecting the clock signal and the start signal between pixel ICs arranged in the same row.

The circuit board may have the plurality of light-emitting elements arranged on the one surface on which the plurality of pixel ICs are arranged, and a third wiring region and a fourth wiring region may be disposed on the circuit board, the third wiring region connecting one end of each of the plurality of light-emitting elements to the first output port of the plurality of pixel ICs, and the fourth wiring region connecting the other end of each of the plurality of light-emitting elements to a power source.

The first wiring region may have a greater wiring width than the second wiring region.

According to an example embodiment of the present disclosure, provided is method of controlling an electronic apparatus, the method including: receiving control information for controlling each of a plurality of light-emitting elements; and sequentially outputting a driving current to a plurality of first pixel integrated circuits (ICs) arranged in a first column and a plurality of second pixel ICs arranged in a second column using one source signal within a specified time period based on the control information.

The method may further include outputting a first start signal to the pixel IC arranged in the first column among the plurality of first pixel ICs, and outputting a second start signal to the pixel IC arranged in the first column among the plurality of second pixel ICs.

In the outputting of the first start signal, the first start signal may be generated, which is turned on during one clock signal period within the specified time period, and in the outputting of the second start signal, the second start signal may be generated, which is turned on during one clock signal period within the specified time period, the second start signal being turned on during the one clock signal period after a time acquired by multiplying the clock signal period by the number of pixel ICs in one column from a turn-on time point of the first start signal.

The method may further include outputting a clock signal operated at a specified period to the plurality of pixel ICs.

In the outputting the driving current using the source signal, the driving current may be output using the source signal, the driving current having a current magnitude corresponding to brightness information of the pixel IC selected by the clock signal and the start signal.

The method may further include outputting a third start signal to the first pixel IC in the first column, the third start signal being turned on in a period unit in which the clock signal period is multiplied by the number of the plurality of first pixel ICs and the plurality of second pixel ICs.

According to an example embodiment of the present disclosure, provided is a non-transitory computer-readable recording medium storing instructions, which, when executed by at least one processor, comprising processing circuitry, of an electronic apparatus, individually and/or collectively, cause the electronic apparatus to perform a method, the method including: receiving control information for controlling each of a plurality of light-emitting elements, and sequentially outputting a driving current to a plurality of first pixel integrated circuits (ICs) arranged in a first column and a plurality of second pixel ICs arranged in a second column using one source signal within a specified time period based on the control information.

### BRIEF DESCRIPTION OF THE DRAWINGS

The above or other aspects, features, and advantage of certain embodiments of the present disclosure will be more apparent from the following detailed description, taken in conjunction with the accompanying drawings, in which:

FIG. 1 is a diagram illustrating an example operation of the backlight unit according to various embodiments;

FIG. 2 is a timing diagram illustrating an example of a waveform of a signal output from a driver integrated circuit (IC) in FIG. 1 according to various embodiments;

FIG. 3 is a diagram illustrating an example operation sequence of a plurality of light-emitting elements according to various embodiments;

FIG. 4 is a block diagram illustrating an example configuration of an electronic apparatus according to various embodiments;

FIG. 5 is a block diagram illustrating an example configuration of the electronic apparatus according to various embodiments;

FIG. 6 is a block diagram illustrating an example configuration of the backlight unit according to various embodiments;

FIG. 7 is a diagram illustrating an example of an arrangement between a timing controller and the driver IC according to various embodiments;

FIG. 8 is a diagram illustrating an example wiring configuration of the backlight unit according to various embodiments;

FIG. 9 is a diagram illustrating an example wiring configuration of the backlight unit according to various embodiments; and

FIG. 10 is a flowchart illustrating an example operation of an electronic apparatus according to various embodiments.

### DETAILED DESCRIPTION

The present disclosure may be variously modified and have several example embodiments, and various example embodiments of the present disclosure are thus illustrated in the accompanying drawings and described in detail in this disclosure. However, it should be understood that the scope of the present disclosure is not limited to any specific embodiments, and includes all modifications, equivalents, and alternatives according to the present disclosure. Throughout the accompanying drawings, similar components are denoted by similar reference numerals.

In describing the present disclosure a detailed description of a case where it is decided that a detailed description of the known functions or configurations related to the present disclosure may unnecessarily obscure the gist of the present disclosure may be omitted.

In addition, the disclosure and various embodiments may be modified in several different forms, and the scope and spirit of the present disclosure are not limited to the following embodiments. Rather, the various example embodiments are provided to convey the spirit of the present disclosure to those skilled in the art.

Terms used in the present disclosure are used to describe the various embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the component may be directly coupled to another component or may be coupled to another component through yet another component (for example, a third component).

On the other hand, if any component (for example, the first component) is mentioned to be “directly coupled with/to” or “directly connected to” another component (for example, the second component), it should be understood that component (for example, the third component) may not be present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (for example, an embedded processor) that may perform the corresponding operations or a general-purpose processor (for example, a central processing unit (CPU) or an application processor) that may perform the corresponding operations by executing one or more software programs stored in a memory device.

In the various embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor 160 except for a “module” or a “part” that needs to be implemented by specific hardware.

Operations performed by the modules, the programs, or other components according to various embodiments may be executed in a sequential manner, a parallel manner, an iterative manner, or a heuristic manner, at least some of the operations may be performed in a different order or be omitted, or other operations may be added.

The various elements and areas in the drawings are schematically illustrated. Therefore, the spirit of the present disclosure is not limited by relative sizes or intervals illustrated in the accompanying drawings.

An electronic apparatus according to the various embodiments of the present disclosure may include, for example, at least one of a smartphone, a tablet personal computer (PC), a desktop PC, a laptop PC, or a wearable device. The wearable device may include at least one of an accessory-type wearable device (for example, a watch, a ring, a bracelet, an anklet, a necklace, glasses, contact lenses, or a head-mounted device (HMD)), a textile or clothing-integrated wearable device (for example, an electronic clothing), a body-attached wearable device (for example, a skin pad or a tattoo), or a biologically implantable circuit.

In various embodiments, the electronic apparatus may include, for example, at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box (e.g., Samsung HomeSync™, AppleTV™, or Google TV™), a game console (e.g., Xbox™ or PlayStation™), an electronic dictionary, an electronic key, a camcorder, or an electronic picture frame. Meanwhile, among the electronic apparatuses described above, a device including a display may be referred to as an electronic apparatus. The electronic apparatus according to the present disclosure may be a set-top box or a PC that provides an image to the electronic apparatus even without the display.

Various example embodiments of the present disclosure are described in greater detail with reference to the accompanying drawings.

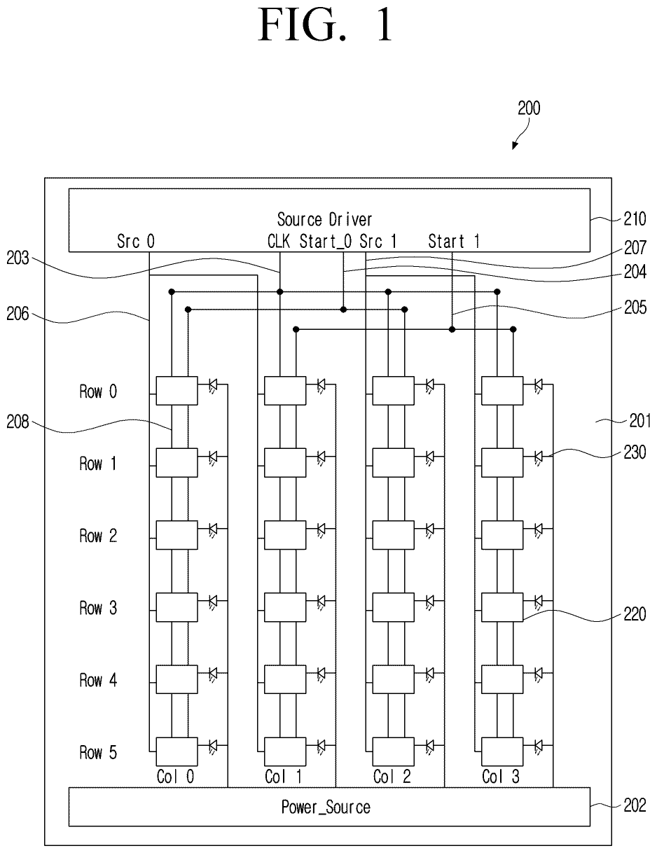

FIG. 1 is a diagram illustrating an example operation of the backlight unit according to various embodiments.

Referring to FIG. 1, a backlight unit 200 is a component that provides light to a display panel such as liquid crystal display (LCD), and supplies electricity to a light-emitting element. Recently, the light-emitting element such as a light-emitting diode (LED) may be used, and the number of the light-emitting elements is increased to improve image quality. In implementation, the light-emitting element may use not only the LED but also an organic light-emitting diode (OLED), a micro LED, or the like.

In this way, the number of pixels covered by one light-emitting element may be reduced as the number of light-emitting elements increases, thereby more accurately express a color that each pixel is intended to express.

Controlling the light-emitting element may involve not simply turning the light-emitting element on or off, but also adjusting a level to which each light-emitting element emits light. This brightness control may be referred to as dimming. The dimming refers to a process of adjusting the brightness or intensity of light from a light source, and the brightness of the light-emitting element may be adjusted using a pulse width modulation (PWM) method, for example, using a time ratio per cycle during which the LED emits light, or by adjusting an amount of current flowing through the light-emitting element.

The dimming may include local dimming that classifies an image (or a screen) into a plurality of regions and individually adjusts the brightness of each region for each classified region. The local dimming may be classified as follows based on a control method of each element included in the plurality of light-emitting elements.

One control method of the plurality of light-emitting elements may be referred to as a Direct method. The Direct method refers to a method for individually driving the light-emitting elements. However, as the number of light-emitting elements increases, resources for individually driving the light-emitting elements may increase.

Other control methods may include an Active Matrix (AM) method and a Passive Matrix (PM) method. The AM method or the PM method refers to a method for arranging the plurality of light-emitting elements into a plurality of columns and a plurality of rows in a matrix form as illustrated in FIG. 1, and controlling each column by row.

The AM method and the PM method are similar to each other to the extent that these methods may sequentially control the plurality of light-emitting elements using a gate control signal. However, the AM method differs from the PM method in that the AM method further includes a hold element. Accordingly, the AM method may maintain a light-emitting operation of the light-emitting element by charging a capacitor of the hold element while the gate control signal is applied thereto. Here, the hold element may be referred to as a pixel integrated circuit (IC).

The hold element may receive a driving current at each specific period and maintain the received driving current until a next time point. Therefore, the AM method may provide the driving current required for the operation of each hold element a single time in one operation period.

Conventionally, as the control is performed in units of columns, an individual source signal may be required for each column, thus requiring a driver IC for generating the source signal and wiring. For example, as illustrated, a configuration including four columns and six rows may require four individual source signals.

For example, the source signal is an analog signal that uses a current source, thus requiring a relatively large circuit configuration. A recent trend toward an increased size requires a method for reducing the number of source signals.

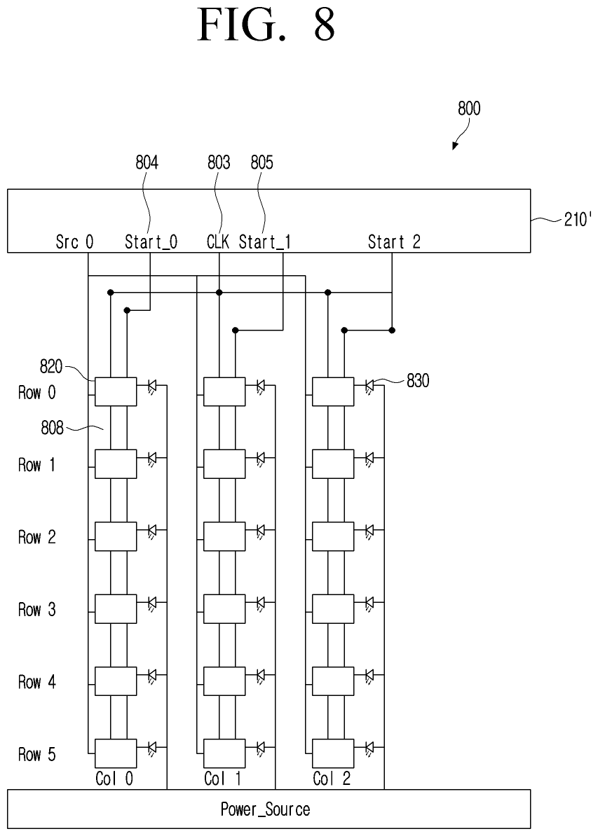

To address this issue, the present disclosure controls the plurality of rows using one source signal. An illustrated example illustrates and describes an example embodiment in which two rows are tied together. However, in implementation, three or more rows may be tied together as one. Such an example is described in greater detail below with reference to FIG. 8.

In addition, even if the plurality of rows are tied together, the backlight unit 200 may configure and output the source signal to individually deliver the driving current to all the pixel ICs arranged in the plurality of rows.

For this operation, the backlight unit 200 may include a circuit board 201, a driver IC 210, a plurality of pixel ICs 220, and a plurality of light-emitting elements (e.g., including various light emitting circuitry) 230.

The circuit board 201 has a configuration in which components included in the backlight unit 200 are arranged, and wirings 203, 204, 205, 206, 207, and 208 for electrical connection among the respective components may be positioned on one surface or two surfaces of the circuit board 201.

A power node(or power source) 202 may provide power to each light-emitting element. The illustrated example illustrates the power node 202 as being connected only to the light-emitting elements. However, in implementation, the power node 202 may be connected to each component included in the backlight unit. In addition, in implementation, the power node 202 may be positioned on each of the two surfaces of the circuit board rather than one surface thereof.

The circuit board may refer to a printed circuit board (PCB), which is a board that provides a circuit by plating copper foil or the like on an insulating plate made of phenol or epoxy resin, and on which components may be mounted. This board may be a single-sided PCB in which wiring is arranged on only one surface, or a double-sided PCB in which wiring is positioned on two surfaces. For ease of description, the following description assumes and describes that the circuit board is the single-sided board. However, in implementation, the circuit board may any type of board, including, for example, the double-sided board.

The driver IC 210 may receive control information from an external source, and generate and output the source signal, a clock signal, and a start signal based on the received control information. To this end, the driver IC 210 may include an input port and a plurality of output ports. In the present disclosure, the corresponding component may be referred to as a driver IC. However, the corresponding component may also be referred to as a driver circuit, a driver device, a signal generation device, a source generation device, etc.

The clock signal may refer to a signal for matching an operation timing of each pixel IC included in the backlight unit. The illustrated example illustrates that the driver IC generates the clock signal and provides the same to other components. However, in implementation, a separate device (e.g., an oscillator) may generate the clock signal and the driver IC 210 may also utilize the clock signal.

The start signal refers to a signal used to select a pixel IC to be operated from the plurality of pixel ICs. The start signal may be turned on a single time within a cycle corresponding to an operation period of the source signal.

The source signal may refer, for example, to an analog signal that provides the driving current to each pixel IC. The source signal may have a greater wiring width than the clock signal or the start signal.

The input port of the driver IC 210 may receive the control information from the timing controller. The timing controller may be referred to as a TCON, and may be a component for outputting digital data corresponding to a grayscale value of an input image. The control information may be the digital data output from the timing controller.

The driver IC 210 may include the plurality of output ports for outputting source signals Src0 and Src1, a clock signal CLK, and start signals Start0 and Start1 described above. For example, a first output port of the driver IC 210 may output the clock signal CLK. The first output port of the driver IC 210 may be connected to a first input port of each of the pixel ICs 220 via the first wiring 203. The first output port may be referred to as a clock output port.

The clock signal may be determined based on the number of image frames, the number of backlight controls per frame, and the number of pixel ICs controlled by one source signal. For example, if a refresh rate of the image is 120 Hz and eight backlight controls are performed per frame, the source signal may be operated at a cycle corresponding to 1920 Hz (e.g., 1/1920 second). In this case, if six pixel ICs are positioned in one row, the clock signal may be operated at 11.52 KHz. If the number of controls per frame or the number of pixels in the row are different, the operation frequency described above may be different.

The illustrated example illustrates that the clock signal CLK is delivered only to the pixel ICs in a first row (Row 0) via the first wiring 203. However, the first wiring 203 that delivers the clock signal CLK may also be disposed on the bottom of each pixel IC and provided to all the pixel ICs.

A second output port of the driver IC 210 may output the first start signal Start0. The first start signal Start0 refers to a signal that is turned on for one period of the clock signal CLK in units of a source signal period, and refers to a signal for selecting a pixel IC to read the source signal from the pixel ICs positioned in a first column (or a third column).

The first start signal Start0 may be connected to the second wiring 204 to thus be connected to a first pixel IC (Col 0, Row 0) in the first column and a first pixel IC (Col 2, Row 0) in the third column. A predetermined (e.g., specified) period may have a time value (1/(120*8)=1/1920) corresponding to a value acquired by multiplying a scanning rate (e.g., 120 Hz) of the display panel by the number of control times (e.g., 8 times) as described above.

In this way, the first start signal Start0 may be delivered only to the first pixel IC (Col 0, Row 0) in the first column and the first pixel IC (Col 2, Row 0) in the third column, and the start signal may then be delivered via the wiring between the pixel ICs. In addition, each pixel IC may not deliver the start signal upon receiving the start signal, and may deliver the start signal to a next pixel IC by delaying the start signal by one clock signal period. To this end, the sixth wiring region 208 for connecting a start input port of each pixel IC and a start output port of the next pixel IC may be disposed.

In addition, a third output port of the driver IC 210 may output the second start signal Start1. The second start signal Start1 refers to a signal that is turned on for one period of the clock signal CLK in units of the source signal period, and refers to a signal for selecting the pixel IC to read the source signal from pixel ICs (Col 1) positioned in a second column (or a fourth column). In this way, a read operation for the second column needs to be performed after all read operations for the first column are finished. Therefore, a turn-on time point of the second start signal Start1 may be different from a turn-on time point of the first start signal Start0 by a time acquired by multiplying the number of pixel ICs in the column by the clock signal period. The second start signal Start1 may be connected to the third wiring 205 to thus be connected to the first pixel IC in the first column (or the third column).

The second start signal Start1 may be delivered only to a first pixel IC (Col 1, Row 0) in the second column and a first pixel IC (Col 3, Row 0) in the fourth column via the third wiring 205, and the start signal may then be delivered via the wiring between the pixel ICs.

In addition, a fourth output port of the driver IC 210 may output the first source signal Src0. The first source signal refers to a signal that sequentially provides the driving current to the pixel ICs in the first column and the pixel ICs in the second column, and may be operated in units of the predetermined period. The predetermined period may be a time value corresponding to 1,920 Hz. For example, if an image has the refresh rate of 120 Hz, the backlight may perform the control operation for the light-emitting element eight times within a refresh period of the frame. These values are examples, and other values may be used in implementation.

The first source signal Src0 may be provided to each pixel IC in the first column and each pixel IC in the second column via the fourth wiring 206.

A fifth output port of the driver IC 210 may output the second source signal Src1. The illustrated example illustrates and describes that the driver IC 210 outputs two source signals. However, in implementation, the driver IC 210 may output only one source signal or may output three or more source signals. That is, in implementation, the driver IC may be used in various ways depending on the number of sources output by the driver IC and the number of light-emitting elements used in the backlight unit.

The first source signal Src0 may be provided to each pixel IC in the third column and each pixel IC in the fourth column via the fifth wiring 207.

The pixel IC 220 may be disposed in the plurality of columns and the plurality of rows. For example, the pixel IC 220 in the illustrated example may be disposed in four columns and six rows. In addition, the pixel IC may be positioned to correspond to an arrangement of the plurality of light-emitting elements. That is, one pixel IC may control one light-emitting element. The pixel IC may be referred to as a pixel circuit, a hold IC, a hold circuit, an LED driver, an LED driver element, or the like.

The pixel IC 220 may receive the source signal, the clock signal CLK, or the start signal, and may provide the driving current to the light-emitting element in response thereto.

To this end, the pixel IC 220 may include the input port for outputting the source signal, the clock signal CLK, or the start signal described above, and the output port for providing the driving current to the light-emitting element.

The output port of the pixel IC 220 may be connected to a cathode terminal of the corresponding light-emitting element. In addition, an anode of the light-emitting element may be connected to the power node 202. Accordingly, if the current flows to the output port of the pixel IC 220, the light-emitting element 230 may output light, and light may have a light amount corresponding to the flowing current.

If no current flows to the output port of the pixel IC 220, the light-emitting element emits no light.

As described above, the pixel IC 220 may output a current from the source port in a hold state, and may thus be maintained until an execution time point of the read operation of the next pixel IC, e.g., in units of the source signal period.

The first input port of the pixel IC 220 may be a clock input port, and may receive the clock signal CLK output from the first output port of the driver IC 210 via the first wiring 203.

A second input port of the pixel IC 220 may be the start input port and receive the first start signal Start0 or the second start signal Start1 depending on a position of the pixel IC. The pixel IC 220 may include the second output port that outputs the received start signal at a time point delayed by a predetermined time. In this way, the start signal may be delayed to a predetermined time point and delivered to the next pixel IC. Accordingly, the plurality of pixel ICs in one column may be sequentially turned on and operated.

A third input port of the pixel IC 220 may be a source input port. The pixel IC 220 may amplify the driving current in the source signal while the clock signal CLK and the start signal are turned on, and output the amplified driving current to the light-emitting element.

The plurality of light-emitting elements 230 may be arranged in the plurality of columns and the plurality of rows. The number of the columns and rows may correspond to the plurality of pixel ICs 220. The illustrated example illustrates one light-emitting element positioned at one location. However, a configuration controlled by one pixel IC may be one light-emitting element, or light-emitting elements connected in series, light-emitting element connected in parallel, or a light-emitting element array having a plurality of light-emitting elements connected in series and in parallel.

Each of the plurality of light-emitting elements 230 may receive the driving current from the corresponding pixel IC and output light based on the received driving current.

As described above, the backlight unit according to an example embodiment may operate the pixel ICs arranged in the plurality of columns using one source signal, thereby reducing the number of source signals and reducing the number of wirings and driver ICs.

FIG. 1 illustrates and describes a case where the first and second columns are tied together and operated as one. However, in implementation, the first and third columns may be tied together and operated, which may use various mapping methods.

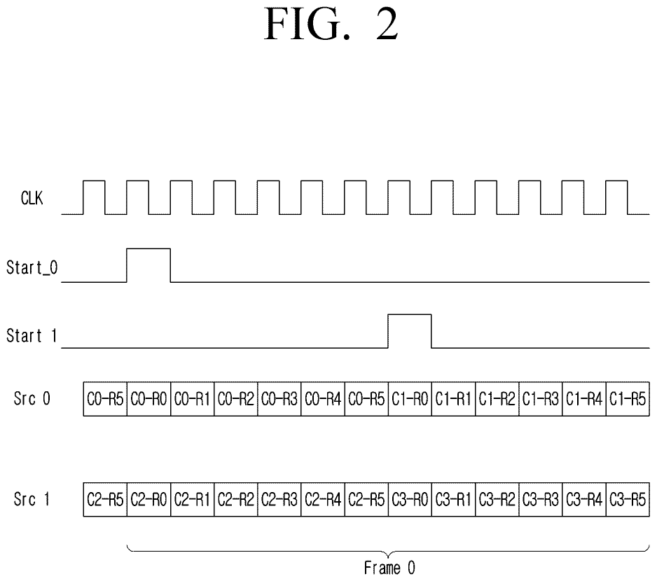

FIG. 2 is a timing diagram illustrating an example of a waveform of the signal output from the driver IC in FIG. 1 according to various embodiments.

Referring to FIG. 2, the driver IC may generate and output the clock signal CLK, the start signal, or the source signal.

Conventionally, one clock signal, one start signal, and four source signals may be required to control the plurality of light-emitting elements arranged in four columns as illustrated in FIG. 1.

However, in the present disclosure, two columns may be controlled using one source signal, and one clock signal, two start signals, and two source signals. The two source signals may be operated in the same manner, and a control method for the left two columns in FIG. 1 is described below in greater detail.

The clock signal refers to a clock signal having a predetermined frequency, and may have a frequency determined based on the refresh rate of an image, the number of backlight controls per frame, and the number of pixel ICs in the column.

The first start signal and the second start signal may be signals for determining an operation sequence of the pixel ICs included in a group. As described above, the first pixel IC in each column may receive the start signal through the driver IC, and the other pixel IC may receive the start signal through the pixel IC disposed in a previous row. The start signal may be synchronized to a transition time point of the clock signal as illustrated.

In the present disclosure, if the first start signal is turned on, the first pixel IC in the first column may perform the read operation for the source signal. Therefore, the driver IC may provide the driving current to the first pixel IC in the first column through the source signal at this operation time point. At this time point, the start signal may be turned on only for the first pixel IC in the first column. The read operation may be performed only for the first pixel IC in the first column, and the read operation may not be performed for the other pixels, and the driving current provided in a previous step may be held and maintained.

If the operation for the first IC is completed, the first pixel IC may deliver the start signal to the next pixel, e.g., the second pixel IC.

Accordingly, the operation for the second pixel IC may be performed, and at that time point, the driver IC may provide the driving current for the second pixel IC.

Such an operation may be performed repeatedly, and if all the operations for the first column are completed, it may be confirmed that the second start signal is turned on for controlling the second column at that time point.

Accordingly, the operation for providing the driving current to the second column may proceed after this time point.

In this way, the control operation for the pixel ICs in the first column and the second column may be completed during twelve clock cycles.

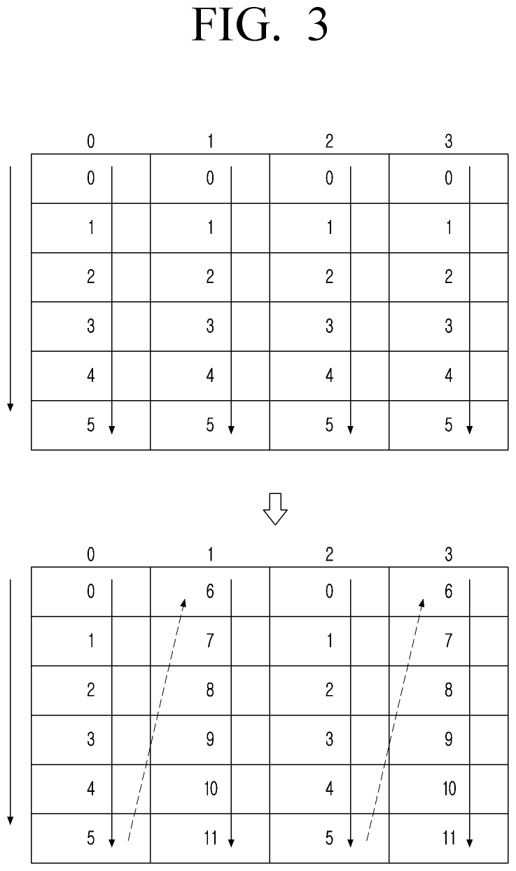

If the operation for the plurality of ICs is organized as described above, it may be expressed as shown in FIG. 3.

FIG. 3 is a diagram illustrating an example operation sequence of the plurality of light-emitting elements according to various embodiments.

FIG. 3 is a diagram illustrating an example operation sequence of the plurality of pixel ICs including four columns and six rows. An upper region in FIG. 3 illustrates an example method for controlling the four columns using four source signals, and a lower region in FIG. 3 illustrates an example method for controlling the four columns using two source signals.

If the four source signals are used, it may be confirmed that each column is operated in the same sequence.

If two source signals are used, the operation may be performed sequentially from the first and third columns, and the first rows of the second and fourth columns are operated after the last rows of the first and third columns are operated.

However, a conventional method may perform the control for six pixel ICs in one period. The present disclosure may perform the control for twelve pixel ICs in one period to thus perform the operation by reducing the number of control times per frame from eight to four times. The present disclosure may maintain the same number of backlight controls per frame as the conventional method by being operated using a clock frequency doubled compared to the conventional method.

Adjusting the operation of the plurality of light-emitting elements to a current value is described with reference to FIGS. 1 to 3. However, as described above, the present disclosure may perform the backlight control multiple times per frame. For example, the present disclosure may selectively perform the operation at a plurality of control time points, and may also use a PWM dimming method. Accordingly, controlling the light-emitting element according to the present disclosure may be referred to as a combination of an analog dimming control method and the PWM dimming control method.

The present disclosure assumes a case of controlling the light-emitting element in the backlight unit, and may also be applied to a process of controlling the OLED or the micro LED that directly emits light. In this case, the backlight unit described above may be referred to as a display unit.

In the process of controlling the plurality of light-emitting elements as described above, the plurality of columns may be controlled using one source signal, thereby reducing costs by reducing the number of driver ICs or simplifying the wiring.

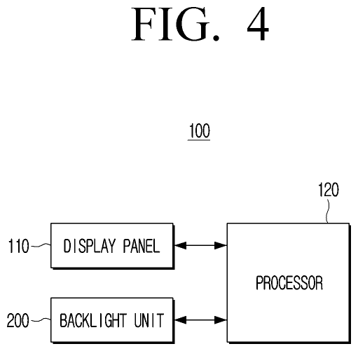

FIG. 4 is a block diagram illustrating an example configuration of an electronic apparatus according to various embodiments.

An electronic apparatus 100 in FIG. 4 refers to a device that controls the backlight unit, and may be a device including the display panel, such as, for example, and without limitation, a television (TV), a desktop personal computer (PC), a laptop, a video wall, a large format display (LFD), a digital signage, a digital information display (DID), a projector display, a digital video disk (DVD) player, a smartphone, a tablet PC, a monitor, smart glasses, a smart watch, or the like, and directly displaying an acquired graphic image.

However, the electronic apparatus 100 is not limited thereto, may be implemented as a device detachable from the display panel, and may include any device that controls the backlight unit.

Referring to FIG. 4, the electronic apparatus 100 may include a display panel 110, the backlight unit (e.g., including a backlight) 200, and a processor (e.g., including processing circuitry) 120.

The display panel 110 may, for example, be a liquid crystal display (LCD). The display panel 110 may also include a driving circuit or the like, which may be implemented in a form such as an a-si thin film transistor (TFT), a low temperature poly silicon (LTPS) TFT, or an organic TFT (OTFT).

FIG. 4 illustrates that the display panel 110 and the backlight unit 200 are illustrated as being separate from each other. However, in implementation, the backlight unit 200 may be a component included in the display panel 110. The display panel 110 may be implemented as a touchscreen combined with a touch sensor, a flexible display, a three-dimensional (3D) display, or the like.

The display panel 110 may display various images. Backlight control information is illustrated and described below as being provided by the processor 120. However, in implementation, the control information may be provided to the backlight unit 200 through the display panel 110.

The backlight unit 200 may generate light and supply the same to the display panel 110. To this end, the backlight unit 200 may include at least one light-emitting element (e.g., a backlight, not illustrated). The backlight unit 200 may be disposed on a rear surface of the display panel to emit light to the display panel to display an image on the display panel.

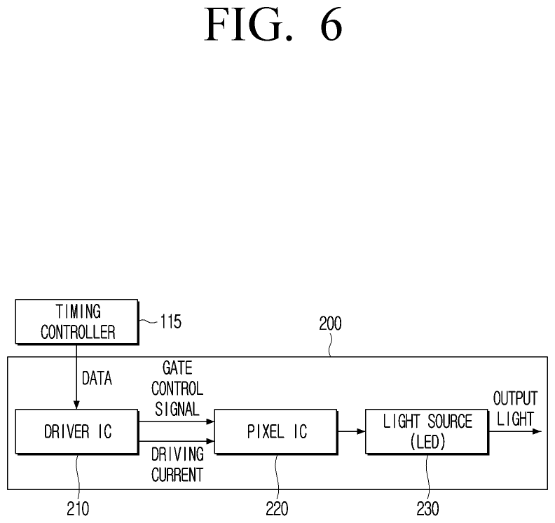

The example configuration and operation of the backlight unit 200 are described in greater detail below with reference to FIG. 6.

The processor 120 may include various processing circuitry and control overall operations of the electronic apparatus 100. For example, the processor 120 may be connected to the configuration of the electronic apparatus including a memory 130, and may control the overall operations of the electronic apparatus by executing at least one instruction stored in the memory 130 as described above. For example, the processor 120 may be implemented not only as one processor 120, but also as a plurality of processors 120.

The instruction may refer, for example, to a small operation unit executed by the processor.

The processor 120 may be implemented as at least one integrated circuit or circuitry (IC) chip and may perform various data processing. The processor 120 may include at least one electrical circuit and may individually or collectively distribute and process the instructions (or programs, data, or the like) stored in the memory.

The processor 120 may include a processor assembly including at least one processing circuit. The processor 120 may include any processing circuit operative to control the performance and operations of at least one component of the electronic apparatus (e.g., the memory and/or a drive device (or sensor)). For example, the processor 120 (e.g., an application processor (AP)) may be implemented as a system on chip (SoC) (e.g., a single chip or chipset). For example, the processor 120 may be implemented as a multiple cores (or at least one core circuit), a plurality of chips, or a plurality of chipsets.

For example, the processor 120 may include at least one processing circuit. In addition, the processor 120 may include at least one processing circuit for individually and/or collectively performing various functions in the present disclosure. As a non-limiting example, at least a portion of the processor 120 may be included in a first chip of the electronic apparatus 100, and at least another portion of the processor 120 may be included in a second chip of the electronic apparatus that is different from the first chip of the electronic apparatus 100.

For example, the processor 120 may include a central processing unit (CPU), a graphics processing unit (GPU), a neural processing unit (NPU), an image signal processor (ISP), a display controller, a memory controller, a storage controller, a communication processor (CP), and/or a sensor interface. These components of the processor 120 are merely examples. The processor 120 may further include other components in addition to the components described above. In addition, some components of the processor 120 may be omitted. In addition, some components of the processor 120 may be included as separate components of the electronic apparatus 100 outside the processor 120. For example, some components of the processor 120 (e.g., a memory controller) may be included in another component (e.g., at least a portion of the memory, an interface (e.g., being available for its connection to at least one component of the electronic apparatus 100), or a display). Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 120 may cause other components of the electronic apparatus 100 to perform various operations by executing the instructions stored in the memory. For example, the processor 120 may be connected to the components such as the memory, the display panel 110, the backlight unit 200, or the like, and control the operation of the electronic apparatus 100.

The processor 120 may process a setting value, a function command, or the like based on a pre-stored control program or control data, and output a control signal related to a function that the electronic apparatus may perform or a communication signal for the communication with an external electronic apparatus.

The processor 120 may control the display panel 110 and the backlight unit 200 to generate an image corresponding to acquired content if content is acquired and to display the generated image. For example, the processor 120 may control the display panel 110 to display a screen corresponding to an image if the image is received.

The processor 120 may generate control information for controlling each of the plurality of light-emitting elements based on the image and provide the control information to the backlight unit. Here, the control information may be the grayscale value to be displayed by each light-emitting element. Alternatively, instead of the grayscale value, the control information may be a current value to be supplied to each light-emitting element or a specific digital control value corresponding to the current value.

The processor 120 may include a timing controller (TCON) that outputs digital data corresponding to the grayscale value of the input image. The timing controller is illustrated and described as a component of the processor 140 above. However, in implementation, the timing controller may be a component included in the display panel. The timing controller may include an interface capable of driving more than thirty-two times per frame.

The processor 120 may not generate the control information, but the display panel 110 that receives the image may generate the control information and provide the same to the backlight unit 200.

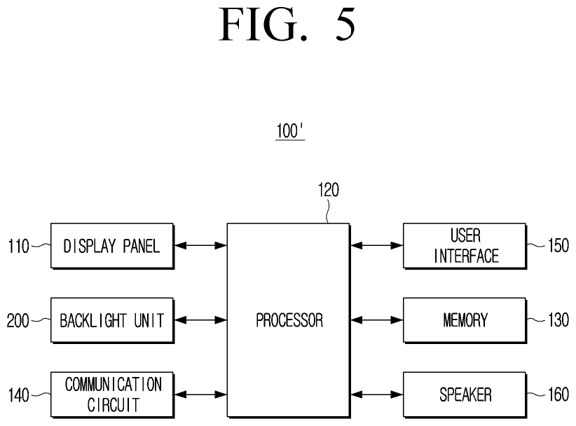

Although only the brief configuration configuring the electronic apparatus 100 is illustrated and described above, various additional configurations may be provided in implementation. This configuration is described in greater detail below with reference to FIG. 5.

FIG. 5 is a block diagram illustrating an example configuration of the electronic apparatus according to various embodiments.

Referring to FIG. 5, an electronic apparatus 100′ may include the display panel 110, the backlight unit 200, the processor 120, the memory 130, a communication circuit 140, a user interface (e.g., including circuitry) 150, and a speaker 160.

The memory 130 may be implemented as an internal memory, such as a read only memory (ROM) (for example, an electrically erasable programmable read-only memory (EEPROM)), a random access memory (RAM), or the like, included in the processor 120, or may be implemented as a memory separate from the processor 120. In this case, the memory 130 may be implemented as a memory embedded in the electronic apparatus 100 or as a memory detachable from the electronic apparatus 100, depending on a purpose of data storage. For example, data for operating the electronic apparatus 100 may be stored in the memory embedded in the electronic apparatus 100, and data for an expanded function of the electronic apparatus 100 may be stored in the memory detachable from the electronic apparatus 100.

The memory 130 may temporarily store image information generated in a process described below.

The memory 130 may store various contents (e.g., broadcast contents or applications) received through the communication circuit 140 described above.

The memory embedded in the electronic apparatus 100 may be implemented as at least one of a volatile memory (e.g., a dynamic RAM (DRAM)), a static RAM (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)), and the memory detachable from the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)) or an external memory that may be connected to a universal serial bus (USB) port (e.g., a USB memory).

The illustrated example illustrates that the electronic apparatus 100 includes one memory. However, if the memory is classified into the volatile memory and the non-volatile memory and referred to in this way, the electronic apparatus 100 may also be referred to as including a plurality of memories.

The communication circuit 140 is a component for performing communication with various types of external devices using various types of communication methods. The communication circuit 140 may include a wireless fidelity (Wi-Fi) module, a Bluetooth module, an infrared communication module, a wireless communication module, or the like. Here, each communication module may include at least one hardware chip or hardware circuit.

The Wi-Fi module and Bluetooth module may perform the communication in a Wi-Fi manner and a Bluetooth manner, respectively. In case of using the Wi-Fi module or the Bluetooth module, the communication interface 160 may first transmit and receive various connection information such as a service set identifier (SSID) or a session key, and connect the communication based on this connection information, and then transmit and receive various information.

The infrared communication module may perform the communication based on infrared data association (IrDA) technology that wirelessly transmits data in a short distance using an infrared ray between visible and millimeter waves.

In addition to the above-described communication methods, the wireless communication module may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G).

The communication circuit 140 may include at least one of a local area network (LAN) module, an Ethernet module, or a wired communication module that performs the communication using a pair cable, a coaxial cable, an optical fiber cable, or an ultra wide-band (UWB) module.

In an example, the communication circuit 140 may use the same communication module (e.g., the Wi-Fi module) to communicate with the external device, such as a remote control, and an external server.

In another example, the communication circuit 140 may use a different communication module (e.g., the Wi-Fi module) to communicate with the external device, such as the remote control, and the external server. For example, the communication circuit 140 may use at least one of the Ethernet module or the Wi-Fi module to communicate with the external server, and may use the Bluetooth (BT) module to communicate with the external device such as the remote control device. However, this case is only an embodiment, and the communication circuit 140 may use at least one communication module among various communication modules in case of communicating with the plurality of external devices or external servers.

The communication circuit 140 may include at least one of a high definition multimedia interface (HDMI), a mobile high-definition link (MHL), a universal serial bus (USB), a DisplayPort (DP), Thunderbolt, a video graphics array (VGA) port, a red-green-blue (RGB) port, a D-subminiature (D-SUB), or a digital visual interface (DVI).

The communication circuit 140 may receive content. Such content may include various types, such as movies, music videos, dramas, short videos, or the like. In addition, the content may be assumed as a video, and may also be referred to as an image or the video.

The communication circuit 140 may receive an image. The image may include various forms of visual information. For example, the image may include a still image and a moving image (or a video). In addition, the video may include the various forms of visual information that represent a movement of an object using a plurality of continuous still images.

In an example, an image may include a captured image acquired using a sensor (for example, a camera) included in the electronic apparatus, an input image received from the external device through the communication interface, a graphic image generated by the electronic apparatus, or the like.

In an example, the image may include a landscape image whose width is greater than its height (for example, a landscape image or a horizontal image), a portrait image whose height is greater than its width (for example, a portrait image or a vertical image) or the like, depending on a ratio. For example, the landscape image may include an image having a ratio of 16:9, and a portrait image may include an image having a ratio of 9:16. The specific numbers are provided as examples for the convenience of description, and the present disclosure is not limited thereto.

In an example, the image may include various resolutions based on the number of pixels included in the image (the product of the number of pixels in a horizontal direction and the number of pixels in a vertical direction). For example, the image may include a high-resolution image (such as full high-definition (FHD, 1920×1080 pixels) or 8K (7680×4320 pixels)) and a low-resolution image (such as 640×480 pixels) based on a resolution.

In an example of the present disclosure, each of the plurality of still images included in the video may represent a frame (or an image frame).

According to an example, the video may include the plurality of frames, and each of the plurality frames may correspond to one screen output by the electronic apparatus. For example, the number of frames (or the number of screens) that the electronic apparatus outputs for one second is referred to as a frame rate, and the frame rate may be expressed in units of frames per second (fps) or hertz (Hz). In an example, a video having 60 fps may represent a video including 60 frames for 1000 millisecond (ms).

The communication circuit 140 may receive, from the external device, not only content but also information necessary for providing various applications and services of the electronic apparatus 100.

The user interface 150 may include various circuitry and receive a command (e.g., a user control command). The user control command may be intended for receiving content or a source signal. The user interface 150 may be implemented as a physical component such as a button, or may be implemented as a touch panel. In implementation, the user interface 150 may be a touchscreen combined with the display panel 110.

The speaker 160 may output sound. Specifically, the speaker 160 may be a component for outputting various audio data processed in an input/output interface as well as various notification sounds or voice messages.

As described above, the electronic apparatus according to the present disclosure may tie the plurality of columns together and control the same using one source signal, thereby reducing a product generation cost of the backlight unit and ultimately reducing a product production cost of the electronic apparatus.

FIG. 6 is a block diagram illustrating an example configuration of the backlight unit according to various embodiments.

Referring to FIG. 6, the backlight unit 200 may include the driver IC 210, the plurality of pixel ICs 220, and the plurality of light-emitting elements (e.g., including light emitting circuitry) 230.

The driver IC 210 may output the driving current in an analog form based on the digital data. The driver IC may receive the control information via a timing controller 115.

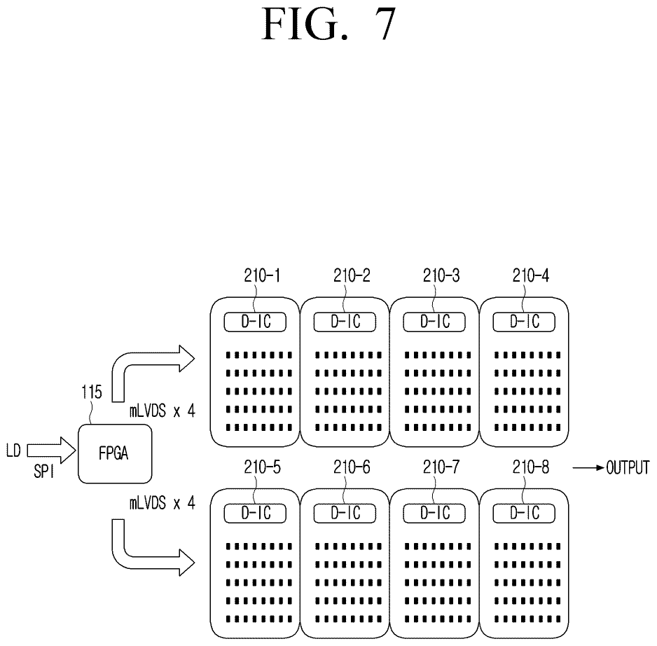

The example illustrates that one driver IC is disposed for one backlight unit 200. However, in implementation, a plurality of driver ICs may be arranged. This configuration is described in greater detail below with reference to FIG. 7.

The driver IC 210 may receive the control information from the external source, and generate and output the source signal, the clock signal, and the start signal based on the received control information.

For example, the driver IC 210 may generate and output the clock signal having the operation frequency determined based on the number of image frames, the number of backlight controls per frame, and the number of pixel ICs controlled by one source signal.

The driver IC 210 may generate the start signal for selecting the pixel IC to be operated in each column. The number of the start signals may vary depending on a method for tying the columns together. However, a case where two start signals are used is first described.

If two start signals are used, the driver IC 210 may generate and output the first start signal, which is turned on during one period of the clock signal CLK in units of the source signal period. The driver IC 210 may generate and output the second start signal, which is turned on during one period of the clock signal CLK in units of the source signal period. Here, the turn-on time point of the second start signal Start1 may be different from the turn-on time point of the first start signal Start0 by the time acquired by multiplying the number of pixel ICs in the column by the clock signal period. The start signal may be referred to as a gate control signal.

The driver IC 210 may generate and output the source signal. Here, the source signal refers to a current signal for sequentially providing the driving current to the pixel ICs in the plurality of columns, and may be operated in units of a predetermined period.

The pixel IC 220 may be disposed in the plurality of columns and the plurality of rows. In addition, each pixel IC 220 may receive the source signal, the clock signal CLK, and the start signal, and provide the driving current to the light-emitting element in response thereto.

For example, if the start signal is turned on and the clock signal is turned on, the pixel IC 220 may amplify the driving current flowing through the source signal and provide the amplified driving current to the light-emitting element 230. The pixel IC 220 may hold and maintain the amplified driving current until a next control time point. Accordingly, the light-emitting element may output light having a light amount corresponding to a current driving current until the next control time point.

Each of the plurality of light-emitting elements 230 may receive the driving current from the corresponding pixel IC and may output light based on the received driving current. The light-emitting element may be an LED, but is not limited thereto, and may include the light-emitting element in the OLED, the light-emitting element in the micro LED, or the like.

As described above, the backlight unit according to an embodiment may operate the pixel ICs in the plurality of columns using one source signal, thereby reducing the number of source signals and reducing the number of wirings and driver ICs.

The description describes the present disclosure is operated by the backlight unit with reference to FIG. 6. However, in implementation, the light-emitting element may be the light-emitting element in the OLED or the LED in the micro LED. In this case, each light-emitting element may correspond to one pixel in an image, or may be a sub-pixel corresponding to a specific color in a pixel.

FIG. 7 is a diagram illustrating an example arrangement between the timing controller and the driver IC according to various embodiments.

Referring to FIG. 7, the timing controller 115 may be implemented as a field programmable gate array (FPGA), and each of the plurality of driver ICs 210-1 to 210-8 may individually output the digital data corresponding to the grayscale value of the input image.

Each of the plurality of driver ICs may provide the start signal and the driving current for controlling the plurality of pixel ICs as described with reference to FIG. 1.

Each of the plurality of driver ICs 210 may output the driving current in the analog form that corresponds to each of the plurality of pixel ICs based on the digital data.

Each of the plurality of pixel ICs 220 may amplify the driving current output from the corresponding driver IC and output the amplified driving current to the backlight unit. Each of the plurality of pixel ICs may output the amplified driving current in the hold state.

The timing controller, the plurality of driver ICs, and the plurality of pixel ICs illustrated in FIG. 7 are examples and may be implemented in various other forms.

FIG. 7 illustrates a case of using eight driver ICs. However, this number is merely an example, and the driver ICs may be implemented having various numbers. In the above description, the driver IC, the plurality of pixel ICs controlled by the driver ICs, and the plurality of light-emitting elements may be classified as one module unit.

FIG. 8 is a diagram illustrating an example wiring configuration of the backlight unit according to various embodiments.

Referring to FIG. 8, a backlight unit 800 may include a circuit board 801, a driver IC 210′, a plurality of pixel ICs 820, and a plurality of light-emitting elements 830.

The driver IC 210′ may receive the control information from the external source, and generate and output the source signal, the clock signal, and the start signal based on the received control information. To this end, the driver IC 810 may include an input port and a plurality of output ports.

The input port of the driver IC 210′ may receive the control information from the timing controller.

The driver IC 210′ may include the plurality of output ports for outputting the source signal Src0, the aforementioned clock signal CLK and start signals Start0, Start1, and Start2. For example, a first output port of the driver IC 210′ may output the clock signal CLK. A first output port of the driver IC 210′ may be connected to the first input port of each pixel IC 820 via the first wiring 803. The first output port may be referred to as the clock output port.

A second output port of the driver IC 210′ may output the first start signal Start0. The first start signal Start0 refers to a signal that is turned on during one period of the clock signal CLK in units of the source signal period, and refers to a signal for selecting the pixel IC to read the source signal among the pixel ICs positioned in the first column.

The first start signal Start0 may be connected to a second wiring 804 and connected to the first pixel IC (Col 0, Row 0) in the column. Here, the predetermined period may have the time value (1/(120*8)=1/1920) corresponding to the value acquired by multiplying the scanning rate (e.g., 120 Hz) of the display panel by the number of control times (e.g., 8 times) as described above.

In this way, the first start signal Start0 may be delivered only to the first pixel IC in the first column, and the start signal may then be delivered via a wiring 808 between the pixel ICs. Each pixel IC may not deliver the start signal upon receiving the start signal, and may deliver the start signal to a next pixel IC by delaying the start signal by one clock signal period.

A third output port of the driver IC 210′ may output the second start signal Start1. The second start signal Start1 refers to a signal that is turned on for one period of the clock signal CLK in units of the source signal period, and refers to a signal for selecting the pixel IC to read the source signal from pixel ICs positioned in a second column. In this way, a read operation for the second column needs to be performed after all read operations for the first column are finished. Therefore, a turn-on time point of the second start signal Start1 may be different from a turn-on time point of the first start signal Start0 by the time acquired by multiplying the number of pixel ICs in the column by the clock signal period.

A fourth output port of the driver IC 210′ may output the third start signal start2. The third start signal start2 refers to a signal that is turned on during one period of the clock signal CLK in units of the source signal period, and refers to a signal for selecting the pixel IC to read the source signal among the pixel ICs positioned in the third column. In this way, the read operation of the third column needs to be performed after the read operations for both the first and second columns are finished. Therefore, a turn-on time point of the third start signal start2 may be different from the turn-on time point of the second start signal Start1 by the time acquired by multiplying the number of pixel ICs in the column by the clock signal period.

A fifth output port of the driver IC 210′ may output the first source signal Src0. The first source signal refers to a signal that sequentially provides the driving current to the pixel ICs in the first column, the pixel ICs in the second column, and the pixel ICs in the third column, and may be operated in units of the predetermined period. Here, the predetermined period may be a time value corresponding to 1,920 Hz.

The pixel IC 820 may be disposed in the plurality of columns and the plurality of rows. For example, the pixel IC 820 in the illustrated example may be disposed in three columns and six rows. The pixel IC may be positioned to correspond to an arrangement of the plurality of light-emitting elements. That is, one pixel IC may control one light-emitting element. The arrangement in each pixel IC is the same as or similar to that shown in FIG. 1, and a redundant description may not be repeated here.

The plurality of light-emitting elements 830 may be arranged in the plurality of columns and the plurality of rows. Each of the plurality of light-emitting elements 230 may receive the driving current from the corresponding pixel IC and output light based on the received driving current.

As described above, the backlight unit according to this embodiment may operate the pixel ICs in three columns using one source signal, and thus may reduce the number of source signals and reduce the number of wirings and driver ICs.

FIG. 8 illustrates and describes an example in which three columns are tied together to be operated by one source signal. However, in implementation, instead of tying three columns, four or more columns may be tied together. The illustrated example describes an embodiment of using the plurality of start signals for selecting each column while operating the plurality of columns by one source signal.

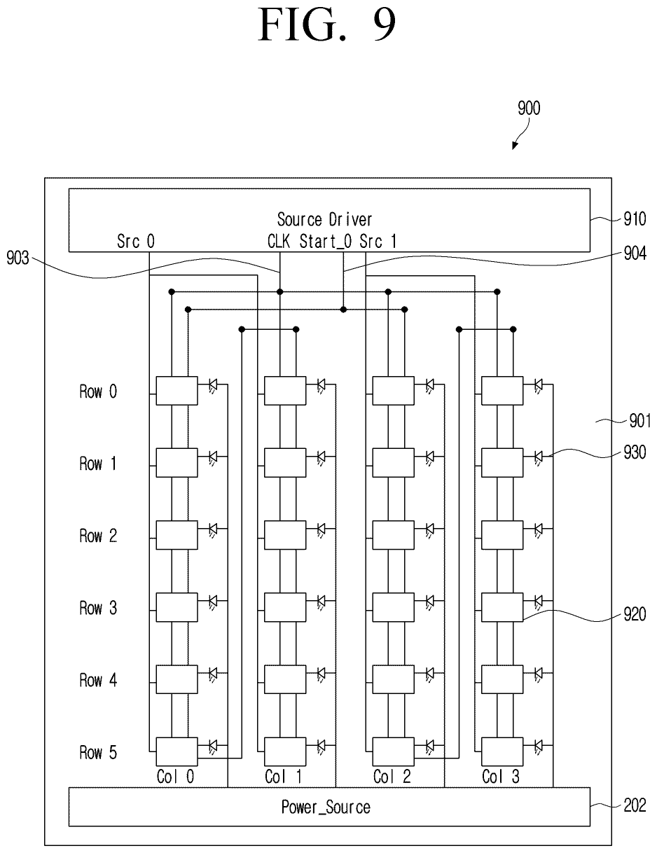

However, in implementation, the wiring type may be adjusted without increasing the start signals. This configuration is described in greater detail below with reference to FIG. 9.

FIG. 9 is a diagram illustrating an example wiring configuration of the backlight unit according to various embodiments.

Referring to FIG. 9, a backlight unit 900 may include a circuit board 901, a driver IC 910, a plurality of pixel ICs 920, and a plurality of light-emitting elements 930.

The driver IC 910 may receive the control information from the external source, and generate and output the source signal, the clock signal, and the start signal based on the received control information. To this end, the driver IC 910 may include an input port and a plurality of output ports.

The input port of the driver IC 910 may receive the control information from the timing controller.

The driver IC 910 may include the plurality of output ports for outputting the source signal Src0, the clock signal CLK, and the start signal Start0 described above. For example, a first output port of the driver IC 910 may output the clock signal CLK. The first output port of the driver IC 910 may be connected to a first input port of each pixel IC 920 through a first wiring 903. The first output port may be referred to as the clock output port.

A second output port of the driver IC 910 may output the start signal Start0. The first start signal start refers to a signal that is turned on during one period of the clock signal CLK in units of the source signal period, and refers to a signal for selecting the pixel IC to read the source signal among the pixel ICs positioned in the first column (or the third column).

The first start signal Start0 may be connected to a second wiring 904, and may be connected to the first pixel IC (Col 0, Row 0) in the column. Here, the predetermined period may have the time value (1/(120*8)=1/1920) corresponding to the value acquired by multiplying the scanning rate (e.g., 120 Hz) of the display panel by the number of control times (e.g., 8 times) as described above.

In this way, the first start signal Start0 may be delivered to the first pixel IC in the first column (or the third column), and the start signal may then be delivered via the wiring between the pixel ICs. Each pixel IC may not deliver the start signal upon receiving the start signal, and may deliver the start signal to the next pixel IC by delaying the start signal by one clock signal period.

FIG. 1 illustrates that two start signals are used, and FIG. 8 illustrates that three start signals are used. FIG. 9 illustrates that one start signal is used.

FIGS. 1 and 8 illustrate that the last row of each column does not deliver the start signal to the next pixel IC, while FIG. 9 illustrates that the last row of the first column and the last row of the third column provide the start signal to the pixel IC 920 positioned in the first row of the second column.

FIG. 1 illustrates that the second column begins its operation based on the second start signal, while FIG. 9 illustrates that the second column begins its operation based on the output signal from the last row of the first column. To implement such a configuration, additional wirings may be required in FIG. 9 compared to the existing wirings shown in FIG. 1. However, the number of start signals may be reduced.

As described above, the backlight unit according to an example embodiment may reduce the number of source signals without increasing the number of start signals.

FIG. 9 illustrates that, upon connecting the additional wiring, the last pixel IC in the first column and the first pixel IC of the second column are connected to each other. However, in implementation, the start signal from the last pixel IC in the first column may be provided to the last pixel IC of the second column. In addition, the pixel IC in the second column may be operated from a lower pixel IC to an upper pixel IC, instead of from top to bottom.

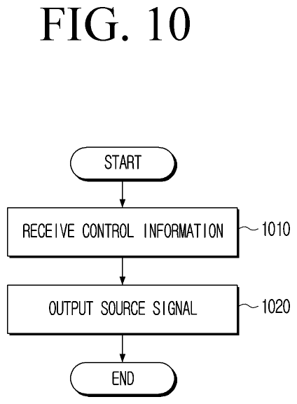

FIG. 10 is a flowchart illustrating an example operation of an electronic apparatus according to various embodiments.

Referring to FIG. 10, the driver IC may receive the control information for controlling each of the plurality of light-emitting elements (1010). The control information may include luminance information of an image to be displayed on the display panel. The control information may include luminance information for each display panel, or average luminance information for a region corresponding to each light-emitting element.

The driver IC may sequentially output the driving current to the plurality of first pixel ICs arranged in the first column and the plurality of second pixel ICs arranged in the second column using one source signal within a predetermined (e.g., specified) time period based on the control information (1020). The source signal may be output in a period for providing the driving current to each of the plurality of ICs by a number greater than or equal to a predetermined number of times for each of the plurality of frames included in the image.

The source signal may be provided to each pixel IC via the wiring commonly connected to the first pixel ICs in the first column and the second pixel ICs in the second column. Each pixel IC may confirm the current magnitude from the source signal at a timing at which the pixel IC is required to be operated based on the received clock signal and the start signal, and provide the confirmed current magnitude to the light-emitting element.

The driver IC may output the clock signal operated at the predetermined period. The clock signal may be commonly delivered to each driver IC in the backlight unit. For example, the output port that outputs the clock signal from the driver IC and the input port that receives the clock signal from each pixel IC may be connected to each other via the wiring.

In implementation, the output port that outputs the clock signal from the driver IC and the first pixel IC of each column may be directly connected to each other via the wiring, and each pixel IC may be connected to the next pixel IC of the same column to deliver the clock signal to the next pixel IC of the same column.

The driver IC may output the start signal. For example, the start signal may be implemented in various ways depending on an operation method. For example, FIG. 9 illustrates a case of using only one start signal, FIG. 1 illustrates a case of using two start signals, and FIG. 8 illustrates a case of using three start signals.

If two start signals are used as shown in FIG. 1, the driver IC may generate the first start signal Start0, which is turned on during one clock signal period within the predetermined time period, and provide the generated first start signal Start0 to the first pixel IC in the first column.

The driver IC may generate the second start signal Start1, which is turned on during one clock signal period within the predetermined time period, the second start signal Start1 being turned on during one clock signal period after the time acquired by multiplying the clock signal period by the number of pixel ICs in one column from the turn-on time point of the first start signal Start0, and provide the generated second start signal Start1 to the first pixel IC in the second column.

If one start signal is used, the driver IC may generate the third start signal, which is turned on during one clock signal period within the predetermined time period in which the source signal is operated, and provide the generated third start signal to the first pixel IC in the first column.

As described above, the control method according to the present disclosure may output the driving current for the plurality of pixel ICs corresponding to the plurality of columns using one source signal, thereby reducing the number of terminals (or wirings) required to output the source signal compared to the conventional method. Accordingly, the wiring of the backlight circuit may be simplified, and the cost may be reduced.

The methods according to at least some of the various embodiments of the present disclosure described above may be implemented in the form of an application capable of being installed on a conventional electronic apparatus.

The methods according to at least some of the various embodiments of the present disclosure described above may be implemented by software upgrade or hardware upgrade of the conventional electronic apparatus.

The methods according to at least some of the various embodiments of the present disclosure described above may be performed through an embedded server disposed in the electronic apparatus, or at least one external server of the electronic apparatus.

According to an embodiment of the present disclosure, the various embodiments described above may be implemented in software including an instruction stored in a machine-readable storage medium (for example, a computer-readable storage medium). A machine may be an apparatus that invokes the stored instruction from the storage medium, may be operated based on the invoked instruction, and may include the electronic apparatus (e.g., electronic apparatus A) according to the disclosed embodiments. If the instruction is executed by the processor, the processor may perform a function corresponding to the instruction directly or using another component under control of the processor. The instruction may include a code provided or executed by a compiler or an interpreter. The machine-readable storage medium may be provided in the form of a non-transitory storage medium. Here, the “non-transitory storage medium” may refer to a tangible device and indicate that this storage medium may not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

According to an embodiment, the methods according to the various embodiments disclosed in the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., terminal devices). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

The various embodiments of the present disclosure may be implemented by software including an instruction stored in the machine-readable storage medium (for example, the computer-readable storage medium). A machine may be an apparatus that invokes the stored instruction from the storage medium, may be operated based on the invoked instruction, and may include the electronic apparatus (e.g., the electronic apparatus 100) according to various embodiments.

If the instruction is executed by the processor, the processor may directly perform a function corresponding to the instruction or other components may perform the function corresponding to the instruction under a control of the processor. The instruction may include a code provided or executed by a compiler or an interpreter.

Although various example embodiments of the present disclosure are illustrated and described as above, the present disclosure is not limited to the above-mentioned embodiments, and may be variously modified by those skilled in the art to which the present disclosure pertains without departing from the gist of the present disclosure, including as claimed in the accompanying claims. These modifications should also be understood to fall within the scope and spirit of the present disclosure.

What is claimed is:

1. An electronic apparatus comprising:
a display panel;
a backlight unit comprising a backlight including a plurality of light-emitting elements; and
at least one processor, comprising processing circuitry, individually and/or collectively, configured to control the display panel to: display a screen corresponding to an image in response to the image being input, and
generate control information configured to control each of the plurality of light-emitting elements based on the image, and provide the generated control information to the backlight unit,
wherein the backlight unit includes:
a plurality of pixel integrated circuits (ICs) arranged in a plurality of columns and a plurality of rows, each configured to provide a driving current to each of the plurality of light-emitting elements, and
a driver IC configured to sequentially output the driving current to a plurality of first pixel ICs arranged in a first column and a plurality of second pixel ICs arranged in a second column using one source signal within a specified time period based on the control information.

2. The apparatus as claimed in claim 1, wherein the driver IC is configured to:
provide a first start signal to the first pixel IC in the first column and a second start signal to the first pixel IC in the second column.

3. The apparatus as claimed in claim 2, wherein the driver IC is configured to:
generate the first start signal, which is turned on during one clock signal period within the specified time period, and
generate the second start signal, which is turned on during one clock signal period within the specified time period,
the second start signal being turned on during the one clock signal period after a time acquired by multiplying the clock signal period by the number of pixel ICs in one column from a turn-on time point of the first start signal.

4. The apparatus as claimed in claim 1, wherein the driver IC is configured to provide a clock signal operated at a specified period to the plurality of pixel ICs.

5. The apparatus as claimed in claim 4, wherein the driver IC is configured to output the driving current using the source signal, the driving current having a current magnitude corresponding to brightness information of the pixel IC selected by the clock signal and the start signal.

6. The apparatus as claimed in claim 1, wherein the driver IC is configured to provide the driving current to each of the plurality of ICs by a number greater than or equal to a specified number of times for each of a plurality of frames included in the image.

7. The apparatus as claimed in claim 1, wherein each of the plurality of pixel ICs is configured to output the driving current from the source signal in a hold state based on a received start signal transitioning and a received clock signal transitioning.

8. The apparatus as claimed in claim 7, wherein each of the plurality of pixel ICs is configured to:
provide the received clock signal to a pixel IC disposed in a next column, and
provide a transitioned start signal to a next pixel IC in the same column after a specified time based on the received start signal transitioning.

9. The apparatus as claimed in claim 1, wherein the driver IC is configured to provide a third start signal to the first pixel IC in the first column, and
a last pixel IC in the first column is configured to:
output the driving current to the light-emitting element in a hold state based on the received start signal transitioning, and
provide the start signal to the first pixel IC in the second column after a specified time.

10. The apparatus as claimed in claim 9, wherein the driver IC is configured to output the third start signal to the first pixel IC in the first column,
the third start signal being turned on in a period unit in which the clock signal period is multiplied by the number of the plurality of first pixel ICs and the plurality of second pixel ICs.

11. The apparatus as claimed in claim 1, further comprising a circuit board on which the driver IC and the plurality of pixel ICs are arranged,
wherein a first wiring region and a second wiring region are disposed on one surface of the circuit board,
the first wiring region being commonly connected to a first output port configured to output the source signal from the driver IC and to a first input port of the first pixel IC and the second pixel IC, and
the second wiring region connecting the clock signal and the start signal between pixel ICs arranged in the same row.

12. The apparatus as claimed in claim 11, wherein the plurality of light-emitting elements are arranged on one surface of the circuit board on which the plurality of pixel ICs are arranged, and
a third wiring region and a fourth wiring region are disposed on the circuit board,
the third wiring region connecting one end of each of the plurality of light-emitting elements to the first output port of the plurality of pixel ICs, and
the fourth wiring region connecting the other end of each of the plurality of light-emitting elements to a power source.

13. The apparatus as claimed in claim 11, wherein the first wiring region has a greater wiring width than a wiring width of the second wiring region.

14. A method of controlling an electronic apparatus, the method comprising:
receiving control information for controlling each of a plurality of light-emitting elements; and
sequentially outputting a driving current to a plurality of first pixel integrated circuits (ICs) arranged in a first column and a plurality of second pixel ICs arranged in a second column using one source signal within a specified time period based on the control information.

15. A non-transitory computer-readable recording medium storing which, when executed by at least one processor, comprising processing circuitry, of an electronic apparatus, individually and/or collectively, cause the electronic device to perform a, the method including:
receiving control information for controlling each of a plurality of light-emitting elements, and
sequentially outputting a driving current to a plurality of first pixel integrated circuits (ICs) arranged in a first column and a plurality of second pixel ICs arranged in a second column using one source signal within a specified time period based on the control information.
